(19) United States
(12) Patent Application Publication
(10) Pub. No.: US 2014/0279038 A1
(43) Pub. Date: Sep. 18, 2014

(54) MULTI-PLATFORM MARKETING, PUBLISHING, DATA COLLECTION, AND ANALYSIS

(71) Applicant: Andrew Lombard, Phoenix, AZ (US)

(72) Inventor: Andrew Lombard, Phoenix, AZ (US)

(21) Appl. No.: 13/801,290

(22) Filed: Mar. 13, 2013

(51) Int. Cl. G06Q 30/02

(52) U.S. Cl. CPC G06Q 30/0269
USPC 705/14.66

(57) ABSTRACT

A social and mobile business tool is provided for managing multi-platform marketing, publishing, and analysis. The marketing and publishing software program provides an intuitive campaign management system and graphical user interface with in-depth, real-time analytics for conducting social, mobile, and digital targeted campaigns. The social and mobile business software program improves how social, mobile and digital campaigns work, by syncing the multi-platform based campaigns together. Simultaneous and full synchronization means a campaign can be launched at the same time across mobile, social and Web platforms, and are fully synchronized so changes to a campaign are reflected across the other platforms immediately. The pairing of simultaneous synchronization with mobile integration and detailed interest and attribute data about what's important to a brand or agency's customers and prospects equates to more intelligent marketing with the ability to react and adjust a campaign thereby leading to stronger sales, and more satisfied, loyal buyers.

### CROSS-REFERENCE TO RELATED APPLICATIONS

This application is a non-provisional application that claims priority benefit of U.S. Provisional Application Ser. No. 61/610,386, filed Mar. 13, 2012; the contents of which are hereby incorporated by reference.

### FIELD OF THE INVENTION

The present invention in general relates to software, and in particular to social and mobile business software for multi-platform marketing, publishing, data collection and analysis.

### BACKGROUND OF THE INVENTION

Social customer relationship management (CRM) refers to the use of social media services, techniques and technology to enable organizations to engage with their customers. Social CRM is a philosophy and a business strategy, supported by a technology platform, business rules, workflow, processes and social characteristics, designed to engage the customer in a collaborative conversation in order to provide mutually beneficial value in a trusted and transparent business environment. Social CRM is a company's response to the customer's ownership of the conversation. Social CRM has applications in marketing, customer service and sales, including: peer-to-peer customer support, idea management, market research, product launch, and brand reputation management.

Social media measurement or ‘social media monitoring’ is an active monitoring of social media channels for information about a company or organization, usually by tracking various social media content such as blogs, wikis, news sites, micro-blogs such as Twitter, social networking sites, video/photo sharing websites, forums, message boards, blogs, and user-generated content in general as a way to determine the volume and sentiment of online conversation about a brand or topic.

Social media monitoring allows users to find insights into a brands' overall visibility on social media, measure the impact of campaigns, identify opportunities for engagement, and assess competitor activity. Social media monitoring can also provide valuable information about emerging trends and what consumers and clients think about specific topics, brands, or products. Social media monitoring is the work of a cross section of disciplines including market researchers, public relations (PR) staff, marketing teams, social engagement and community staff, agencies, and sales teams. Several different providers have created tools to facilitate the monitoring of a variety of social media channels from blogging to Internet video to Internet forums. This allows companies to track what consumers are saying about their brands and actions. Social media analytics allow marketers to identify sentiment and identify trends in order to accommodate the customer better. Companies can then react to these conversations and interact with consumers through social media platforms.

There are a wide range of monitoring platforms available, from entry-level free tools to much more powerful enterprise tools, each of which provides different functionality and methods to find, manipulate and work with the relevant data. Some tools are geared more towards engagement, offering solutions to track and respond to mentions of a brand, while others are more data-focused, though most tools offer, to varying degrees, a combination of both. However, brands have traditionally struggled to find an efficient way to reach leads across multiple platforms, quickly and simultaneously.

Thus, there exists a need for a social and mobile business tool that allows enterprise brands, and their agency partners, to connect and engage in meaningful ways with their customers and prospects across multiple platforms in a simultaneous and coherent manner.

### SUMMARY OF THE INVENTION

A social and mobile business tool is provided for managing multi-platform marketing, publishing, and analysis. Embodiments of an inventive marketing and publishing software program (referred to herein as “SocialWhirled”) provide an intuitive campaign management system and graphical user interface (GUI) with in-depth, real-time analytics for conducting social, mobile, and digital targeted campaigns. Embodiments of the inventive social and mobile business software program improve how social, mobile and digital campaigns work, by syncing the multi-platform based campaigns together in a way that is truly impactful. The program helps brands and agencies publish a campaign across multiple platforms at the exact same time, thereby increasing overall campaign effectiveness. Simultaneous and full synchronization means a campaign can be launched at the same time across mobile, social and Web platforms, and is fully synchronized so changes to the campaign are reflected across the other platforms immediately. The pairing of simultaneous synchronization with rich mobile integration and detailed interest and attribute data about what's important to a brand or agency's customers and prospects equates to more intelligent marketing, stronger sales, and more satisfied, loyal buyers. Therefore, the inventive software not only allows brands to market across multiple media platforms at once, but also captures and provides specific data, such as interests and attributes, so businesses know more about their leads and can quickly generate content that is targeted directly to a lead, allowing brands to truly connect with their leads in meaningful ways, and to refine content to continually engage these individuals.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A-1F are a series of block diagrams illustrating the inter relating components of a campaign created with the SocialWhirled platform according to embodiments of the invention;

FIGS. 2A-2H are a series of screenshots illustrating the graphical user interface features of the Brand Manager pages of the Brand Management Toolset according to embodiments of the invention;

FIGS. 3A-3C combine to form a full composite scrolled screenshot view of the Campaign Manager general information page accessed via a pull down menu on the Brand Manager home page of FIG. 2C according to embodiments of the invention;

FIGS. 4A-4B are screenshots of Campaign Manager engagement dashboard pages according to embodiments of the invention;

FIGS. 5A-5F are a series of screenshots of the Campaign Manager layout pages for creating layouts for Web, mobile, and social media platforms according to embodiments of the invention;

FIGS. 6A and 6B combine to form a full composite scrolled screenshot view of the Campaign Manager advanced layout options provided by various coding languages and scripts according to embodiments of the invention;

FIGS. 7A-7C are screenshots of the Campaign Manager coupons pages for available campaign coupons and coupon layout, respectively according to embodiments of the invention;

FIGS. 8A-8G are screenshots of the interactive user features of the Campaign Manager post page according to embodiments of the invention;

FIGS. 9A and 9B are screenshots of the interactive user features of the Campaign Manager featured post page according to embodiments of the invention;

FIGS. 10A-10E are a series of screenshots for controlling post, comments, flagged posts, and flagged comments on the Campaign Manager moderation page according to embodiments of the invention;

FIG. 11 is a screenshot of a page for informing the Campaign Manager of contest results within a campaign ranked by number of votes or views of posts according to embodiments of the invention;

FIG. 12A is a screenshot of a page for the Campaign Manager to set parameters for requiring users to provide information prior to posting within a campaign according to embodiments of the invention;

FIG. 12B is a screenshot of an input screen for end users to input requested information;

FIG. 13 is a screenshot of an exemplary campaign page according to embodiments of the invention; and

FIG. 14 is a schematic diagram illustrating an overall view of communication devices, computing devices, and mediums for implementing a multi-platform marketing, publishing, and analysis tool according to embodiments of the invention.

### DESCRIPTION OF THE INVENTION

The description set forth below in connection with the appended drawings is intended as a description of presently preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application

The present invention has utility as a multi-platform marketing, publishing, and analysis tool. Embodiments of an inventive marketing and publishing software program (referred to herein as “Social Whirled”) provide an intuitive campaign management system and graphical user interface (GUI) with in-depth, real-time analytics for conducting social, mobile, and digital targeted campaigns. In an embodiment, the GUI is Internet or Web browser based. Embodiments of the inventive program enable enterprise brands, and their agency partners, to connect in meaningful ways with their customers and prospects.

Key terms used throughout this disclosure include the following: Brands are the unique identifiers of a specific product or solution—those entities which would typically have their own unique social media page, such as but not limited to a Facebook page. Brand Managers are the administrators of SocialWhirled's campaign management system. Each brand manager has a unique username and password for logging onto SocialWhirled and managing individual brand(s). Campaigns are the messaging and engagement activities across platforms including mobile, social media sites, such as but not limited to Facebook, and the Web used to market a specific brand. SocialWhirled uniquely allows Brand Managers to quickly create consistent campaigns across web pages, social media pages (Facebook pages), and/or mobile sites all from a single platform, and then manage and mediate the posts, comments, coupons, voting, and other engagements of those campaigns. End Users are the visitors to campaigns—on social media (Facebook), on the Web, or through their Mobile devices. End users are the people posting content, commenting on posts, rating and/or voting on posts, engaging coupons and promotions, and submitting their information as requested of them while interacting with a campaign.

Embodiments of the inventive social and mobile business software program improve how social, mobile and digital campaigns work, by syncing the campaigns together in a way that is truly impactful. The program helps brands and agencies publish a campaign across multiple platforms at the exact same time, thereby increasing overall campaign effectiveness. Simultaneous and full synchronization means a campaign can be launched at the same time across mobile, social and Web platforms, and are fully synchronized so changes to the campaign are reflected across all the other platforms immediately. The pairing of simultaneous synchronization with rich mobile integration and detailed interest and attribute data about what's important to a brand or agency's customers and prospects equates to more intelligent marketing, stronger sales, and more satisfied, loyal buyers. Therefore, the inventive software not only allows brands to market across multiple media platforms at once, but also captures and provides specific data, such as interests and attributes, so businesses know more about their leads and can quickly generate content that is targeted directly to a lead, allowing brands to truly connect with their leads in meaningful ways, and to refine content to continually engage these individuals.

Thus for brands, the inventive program helps reach more leads that are specifically targeted, provides insight about what is important to buyers, increases the return on investment (ROI) of creative investments, and scales to keep pace with digital programs as they grow. For agencies, the inventive program is a value-add that can be shared amongst clients and creates longer-term engagements with the agency's clients. Embodiments of the program increase responsiveness while ensuring campaign consistency across platforms, provides data-based insight into what matters most to existing customers and potential buyers, and makes measurement of campaign metrics simple.

The high level of mobile integration offered by embodiments of the marketing and publishing software program allows campaigns to connect brands to their customers and prospects on the devices (desktop computers, laptops, mobile computing devices, tablets, smart phones, gaming and entertainment systems, automotive dashboard displays) their customers use most. With embodiments of the invention, customers may like, share and comment on a mobile-initiated campaign, just as if it was a full Web asset.

Embodiments of program applications (Mobile, social media and Web) are available for both companies with branded products or service offerings, as well as public relation (PR), advertising, and marketing agencies. Companies and agencies may opt for a white-label solution, the most common and default type of campaign, with full control of each campaign plus creative customization (imagery and look) as needed. A white label solution provides campaign managers with the ability to fully customize the look and feel of a campaign without SocialWhirled.com branding.

Embodiments of the inventive program facilitate implementation on the fly, where brands can publish fully customized and highly professional mobile, social and digital campaigns efficiently and quickly based on real time available information. In addition, the inventive program provides brands with the ability to react and adjust a campaign based on dynamic conditions.

Referring now to the figures, FIGS. 1A-1D are a series of block diagrams illustrating the inter-relating components of a campaign created with the SocialWhirled platform according to embodiments of the invention.

FIG. 1A shows how the SocialWhirled campaigns 100 are part of an overarching marketing strategy 102, complimenting traditional marketing including email. As end users 104 participate in the campaign through offers and calls to action 106, the SocialWhirled platform gains “insights” 108 into demographic, engagement, influence, and sentiment of the end user (see FIG. 1E). These insights are used by the campaign manager to refine the campaign 110 to target a specific audience and further add intelligence to traditional marketing (see FIG. 1C schematic for more details). During the campaign, end users can share posts to people in their social network, extending the reach of the campaign to previously unknown prospects. This is depicted as influence prospecting 112.

The schematic of FIG. 1B illustrates an expanded view of the “SocialWhirled Campaign” oval 100 depicted of FIG. 1A for different end user types (prospects, leads, customers). The schematic depicts a flow of how new prospects are identified, how leads can be converted using promotions, and how the campaign can be utilized to promote customer loyalty. Areas of Influence are shown in a darker shade on the schematic and include “influence prospect link” 114, “share to campaign” 116, “share post/campaign with friends” 118, and influence link 120. The areas of influence represents end users (prospects, leads, customers) sharing content to their social network and new end users entering the campaign as a result of clicking on a shared link. As a result of end user interaction, the SocialWhirled platform syncs and appends data to a social Customer Relationship Management (CRM) 122. Social CRM refers to the use of social media services, techniques and technology to enable organizations to engage with their customers.

The schematic of FIG. 1C illustrates an expanded view of “Insight outputs” 108 from FIG. 1A, and provides further detail of how outputs from campaign insights are used as part of an overarching marketing strategy 102. The information from the insight outputs 108 may be: appended to the CRM system 122; used for analytics 124; used to refine or discover a new audience 126; as content for social media 128; and for keywords for searching for content and categorization 130. In an embodiment the overarching marketing strategy 102 includes CRM contacts 132, social contacts 134, a Social Whirled campaign 136, campaign social media sites/advertising 138, and campaign related websites 140.

The schematic of FIG. 1D illustrates how a brand can create many campaigns. User information learned across these campaigns is centralized and appended to the Brand's social CRM.

The schematic of FIG. 1E illustrates how influence is determined and utilized by the campaign manager 150 in embodiments of the invention. The diagram shows different end users 152, engaging with the Socialwhirled platform and how the end users 152 create influence. Influence is an algorithm which measures several factors to determine an end user's 152 ability to bring new end users 152 to a campaign. The inventive application measures the ability of end users 152 to create engaging content (Post 142) which attracts other end users to view, comment 144, and vote 146 on posted content. In addition, influence measures the reach of an end user's social network (how large is their network) and the number of end users which have been attracted by clicking on a shared link. Lastly, the sentiment (positive, negative, neutral) of an end user participating in a campaign is measured based on comments. Negative sentiment 148 from an end user 152N is weighted so campaign managers can take action to counter negative influence.

The schematic of FIG. 1F illustrates publishing across platforms according to embodiments of the invention. The diagram shows the campaign manager 150 configuring a campaign utilizing campaign insights 108 on the Socialwhirled platform 154 and one click publishing 156 the campaign to all platforms (160, 162, 164) simultaneously. The campaign is then available on Facebook and other supported social media platforms 160, a Micro Site (web site) 162, and mobile web 164. Campaign data is available simultaneously across all platforms, so that each end user 152 can engage with the same content regardless of platform used by the end user 152. When an end user 152 creates a post on a platform (160, 162, 164), the post is available to all other end users 152. If the upload to YouTube option is selected, videos are pushed to the designated YouTube channel 166 (as explained further in screenshots 2C and 3C below).

Screenshots

The following screenshots illustrate the graphical user interface and functions of embodiments of the SocialWhirled program. Access to the SocialWhirled program is typically gained by supplying a username and password under the Admin Login link on the SocialWhirled website. The username and password may be user defined or provided by SocialWhirled employees.

FIGS. 2A-2H are a series of screenshots illustrating the graphical user interface features of the Brand Manager pages of the Brand Management Toolset according to embodiments of the invention. FIG. 2A is the Brand Manager home page 200 and is the introductory screen upon log in to SocialWhirled. Brand Manager home page 200 allows a user acting in the role of a Brand or Campaign Manager to select a brand to manage from pull down menu 202. A Brand or Campaign Manager may manage more than one brand. For example, a Brand or Campaign Manager working for an agency may have several clients with separate brands, or a single company may have several product lines that are marketed as separate brands. Once a brand is selected, manage campaign hypertext link 210 may be selected which takes a user to Brand Manager Campaign List screen 200A shown in FIG. 2C. Navigation options in the top right corner of Brand Manager home page 200 include: Campaign Name 204 is a pull-down list of existing campaigns by brand (menu shown expanded in FIG. 2B), selection of which sends the user to the Campaign Manager: General Information screen (see FIG. 3A) for the selected campaign; My Tools 206 is a pull-down list of SocialWhirled management tools that include: Brand Manager whose features and functions are described in FIGS. 2A-2H, Data Miner, also referred to as “Insights” or “Insight Outputs” 108 in FIG. 1A, for data analysis, and Advertising Manager for control of advertising options. Sign Out 212 is a quick link to log out of a Social Whirled account.

FIG. 2C illustrates the Brand Manager Campaign List screen 200A which lists all of existing campaigns (published or unpublished) with action links to show 220—directs the browser to the campaign domain universal resource locator (URL) the user originally set for the campaign, edit 222—takes a user to the Brand Manager: Edit Campaign page (FIG. 2F), allowing the user to edit the name, domain, description, etc., for the campaign, manage 224—takes a user to the Campaign Manager: General Information page (FIG. 3A), allowing the user to edit the details for the campaign, or delete campaigns 226—allows the user to permanently remove the specific campaign from the system, and a conformation overlay 226A appears as shown in FIG. 2G if delete campaigns is selected. The add/remove YouTube link 214 sends the user to a Google sign in page for YouTube to add the content to a campaign, and the add Facebook accounts 216 signs the user on to Facebook to campaigns via a sign in overlay 228 as shown in FIG. 2D. The Add/remove YouTube link 214 provides campaign managers with the ability to connect a YouTube account to the campaign so that uploaded video posts can be simultaneously created on the YouTube channel, extending the campaigns reach. Create a new campaign 218 button starts a new campaign configuration, allowing a user to set campaign administrative values for a new campaign from the Brand Manager: Create Campaign page 200B as shown in FIG. 2E. The Brand Manager: Create Campaign page 200B broadens the reach of digital publishing initiatives across multiple platforms with a consistent message. A campaign name is entered at name input field 230, and a domain is entered at domain input field 232. It is noted that the domain can be a subdomain of socialwhirled.com or a full custom domain. To create the campaign with a custom domain, you must first setup your Domain to use the following production IP address: 174.129.200.60. A description of the new campaign is entered at entry field 234. The type of campaign is checked in field 236 as either white label—the most common and default type of campaign, allowing the user to control the brand imagery and look for their campaign or normal—a campaign that uses Social Whirled branding. Check boxes 238 and 240 are checked if appropriate if the new campaign will also be published to Mobile and/or Facebook—both are selected by default. Check box 242 is to Active Campaign Dashboard—selected by default and when active this value-added feature allows the user to monitor the performance and events of your campaign from the SocialWhirled dashboard. The save button 244 saves the selected settings.

Screenshot 2F illustrates the Brand Manager: Edit Campaign page 200C, and allows the user to edit existing campaign administrative values. Entries are similar to the Brand Manager: Create Campaign page 200B of FIG. 2E and will not be described again. Screenshot 2G illustrates the My Tools pull down menu 206 on the Brand Manager home page 200.

FIGS. 3A-3C combine to form a full composite scrolled screenshot view of the Campaign Manager general information page 300 accessed via a pull down menu 204 on the Brand Manager home page of FIG. 2C according to embodiments of the invention.

The Campaign Manager general information page 300 aggregates the basic settings for a campaign. Changes made to settings on the general information page 300 take immediate effect across all platforms. A user can publish (then unpublish) 302 a campaign from this page, as well as track a configuration checklist 304, upload a brand manager photo 306, and manipulate many details of your campaign configuration. By default, the campaign's Publish State is “not published” and will remain so until a user selects the publish button 302 on the top of the Campaign Manager: General Information page 300. The publish button 302 simultaneously launches a campaign across the Web, Facebook, and Mobile (if the user has selected all three), provided the following basic criteria are met: the user has populated the required layout images, user has populated campaign terms & conditions, and there is at least one post. For a published campaign, the publish button 302 changes to read “unpublish”, thereby allowing brand managers to bring down a published campaign from the selected platforms (Web, Facebook, and Mobile). The campaign checklist 304 automatically checks off the required and optional areas that have been configured. Social Whirled requires the user to create at least one initial campaign post, and to define terms & conditions for a campaign. Campaign photo is an optional area allows the user to upload a thumbnail image that will be displayed when the user (the brand manager) post a reply to a comment or make a comment on a post. Details 308 shows the fields that are the basic configuration settings for a campaign. Many settings have default values which the user may reconfigure as desired. The initial section is populated with user input on the Brand Manager: Create Campaign page 200B. By default, a campaign is checked to “Show campaign” (meaning a campaign may be linked from one site to an associated social networking site) and to Show Campaign Posts in one site (meaning user˜submitted content will be visible with the user's branding on that site). A user can deselect these settings with the check boxes.

A user can optionally enter Interests they like associated with a campaign by typing keywords in the Interests text field 310, then hitting the Add button 312. The dynamic field will offer common keywords as the user types, so the user can select from popular Interest items or create their own new keywords. The user list of individual interests will appear in the summary box 314, and individual interests can there be removed if desired. A user can optionally enter Metatags you′d like associated with their campaign by typing keywords in the Metatags text field 316, separated by a comma, then hitting the Save button 318. These phrases are visible as part of the keyword metatag on the campaign wall. The user is required to add campaign Terms and Conditions 320. An expanded section (not shown) displays an Include Terms & Conditions checkbox, checked by default. When checked, visitors to a campaign must agree to terms before submitting content. Custom Share Message 322, is disabled by default. If the user chooses to create a custom share message on email shares, they click the Edit button, opening an expanded section (not shown) with an “Enable Custom Share Message” checkbox (select to enable), and a text field to enter their custom share message. The Custom Share Message 322 will be displayed as “present” and user text will appear for any email shares.

Contest Rules 324 allows the user to upload an Adobe PDF document of their contest rules which will be displayed under the Learn More button on the campaign wall. Click on the Upload button and select an Adobe PDF file from the navigation pop-up window (not shown). Submit button label 326—Text placed on this area be displayed to end users as the text for the Submit button of the user campaign content. Click on the Edit button to customize user Submit button text. Button hidden—Default is unchecked. If checked, the submit button will be hidden on the campaign wall. Link button visible 328—means a link will appear on a user SocialWhirled campaign linking back to a corporate (or other) website of the user's choice. Click on the Edit button to customize a URL link. Link button URL—The web address the end user will be taken to when the link button is clicked. Link button text—Text submitted in this area be displayed as the label for the Link button. Active buttons 330: Vote default is checked, which means the Vote button is displayed when viewing a post associated with a user's campaign. Rate default is checked, which means the Rate tool will be visible when viewing a post associated with the user campaign. Type of Post 332 are the posts that campaign visitors may upload. Options include video format files, such as Quicktime (.mov) and Windows Media Video (.wmv); audio format files, such as mp3; photo format files, such as JPEG (.jpg) and GIF (.gif); and text content written by the user. SocialWhirled's default is all checked, meaning a campaign will accept all these types of post (video, audio, written, image). A user can deselect any formats they do not wish visitors to submit. In a specific embodiment SocialWhirled allows campaign visitors to upload a video, record a video, or link to a YouTube video in H.264 video format for Safari, Internet Explorer 8, and IE7; or Ogg Theora video format for Firefox, Chrome, or Opera. Audio content is accepted in MP3 and WAV format. Image content is accepted in GIF, JPEG, or PNG format. Written content is accepted as either an Adobe PDF file (limited to 1.0 MB in size) or typed directly into the Text box (limited to 2,000 characters).

Continuing with FIG. 3C, YouTube Controls 334 are set to “False” by default, but the user can select the Edit button to have video posts submitted to a YouTube channel—set in the Brand Manager: Campaign List 200A with the Add YouTube Account . . . button 214 (see FIG. 2C). Sort Posts By 336: Newest (default), but the user can select the Edit button to have posts sorted by Most Views or Most Votes. If the user changes the sorting, the user clicks the Save button to submit their preference. Allow Multiple Entries 338: By default, all campaigns allow multiple entries, meaning end users can submit more than one entry to a campaign. If checked, visitors can submit multiple entries (posts) to a campaign; if unchecked, then each unique visitor can only submit one entry (post). Use Promotions 340: Deselected by default, but if checked, a campaign will keep track of the number of Facebook promotions engaged by end users. # Promotions 342: Zero (0) by default, but click the Edit button to enter the number of promotions available to end users submitting content to the Facebook platform of your campaign. Contest End Date 344: None by default, but click the Edit button to enter a date after which a campaign will no longer accept entries/posts. Clicking on the text box opens up a Calendar feature, allowing the user to select a specific date. Advanced Layout 346: Deselected by default, but if checked, the user gains access to the Advanced Layout page to customize the HTML, JavaScript, and/or cascading style sheets (CSS) for your campaign and performance layout, further extending the customizability of the campaign. (See the optional Campaign Manager: Advanced Layout section in FIGS. 6A and 6B). Facebook App ID 348: Click the Edit button for Facebook App ID to enter the unique page identity from Facebook where a user Facebook campaign application will reside, and click Save.

FIG. 4 is a screenshot of Campaign Manager engagement dashboard page 400 according to embodiments of the invention. SocialWhirled dashboards allow users to quickly gauge the effectiveness of campaigns by performance and event metrics, capturing interest and attribute data to gain meaningful information about a user's audience and campaign end users. These dashboards display data for user published campaigns. The performance tab 402 tracks campaign performance. Click on the data fields 404 to select a date range to measure for your campaign performance metrics, including: Sentiment 406 graph displays three bars: Positive, Neutral, and Negative. The size of each bar is determined by the number of posts for each bar, and the percentage of the total number of posts is displayed on the far right. Keywords/Topics 408 displays the Top 5, Top 10, or Top 20 mentioned keywords, phrases/topics occurring in the conversation from all three campaign platforms. Clicking on a specific keyword will open a page displaying posts mentioning that keyword. Conversion Rate 410 displays the total conversion rate (total conversations divided by number of posts) for a brand across Web, Facebook, Android Mobile devices, and iPhone Mobile devices. Viral Impact 412 displays the number of posts per time period across various social media platforms. Clicking on the Details button shows the time range and total posts count, comments count, and votes count for that range.

FIG. 4B shows the events tab selected on the Campaign Manager engagement dashboard page 400 to arrive at page 400B. The events tab 414 tracks key engagement events. Select options 416 is a pull down menu. Click on the data fields 404 to select a date range you would like to measure for 26 different campaign events (see Table 1) that can be tracked by day, week, or month across the interval you set. Measurable events include:

TABLE 1

```
  1. Campaign wall views
  2. Enter contest clicks
  3. Terms accept clicks
  4. Terms decline clicks
  5. Information request save clicks
  6. Information request cancel clicks
  7. Post photo clicks
  8. Post video clicks
  9. Post audio clicks
10. Post written clicks
11. Post step publish clicks
12. Post step cancel clicks
13. Post publish clicks
14. Post cancel clicks
15. Learn more clicks
16. Link clicks
17. Performance view clicks
18. Vote clicks
19. Rate clicks
20. Share email clicks
21. Share Facebook clicks
22. Share Linkedln clicks
23. Share Twitter clicks
24. Login clicks
25. Facebook connect clicks
26. Login cancel clicks
```

FIGS. 5A-5F are a series of screenshots of the Campaign Manager layout pages 500A, 500B, and 500C for creating layouts for Web, mobile, and social media platforms, respectively according to embodiments of the invention. The Layout section allows a user to consistently configure the look of a campaign across all three delivery platforms: Web, Mobile, and Facebook. In an embodiment, a minimum of four images are required to publish a Social Whirled campaign: the Campaign Header 502, Left Layout 504, Right Layout 506, and Post Page images for the Web platform. All images have an upload/replace button 508 in the middle of the thumbnail. If a user clicks on the Upload button, an open file dialog is displayed and the user can select a file to upload. If an image is already uploaded to your campaign, you can click the Replace button and load a new image, or click the Delete button to remove the current image.

In FIG. 5A, Web tab 510 is selected for a Web layout, and images on this tab are used on brand campaign Web microsite. In an embodiment for a Web microsite the following image resolution specifications may be used: Campaign Header Image 502—this is the Web platform page header, required for White Label campaign, use image sized to 1180×120 pixels; Left Layout 504 the leftside image of the campaign wall, required image, size to 460×490 pixels; Right Layout 506—the right side image of the campaign wall, required image, size to 720×490 pixels; Logo 512—the burst image banner which is displayed on each post, optional image, size to 300×50 pixels; Campaign Arena Image 514—logo displayed when in the campaign arena, optional image, size to 140×105 pixels; Comment logo 516 logo displayed when a comment is posted, optional image, size to 85×80 pixels; Post Page 518—the background image displayed when end users view a post associated with your campaign, required image, size to 1180×490 pixels; and Branded public service announcement (PSA) 520—this image only appears to users who registered for your campaign, optional image, size to 720×160 pixels.

In FIG. 5B, mobile tab 522 is selected for a mobile layout designed for displays found on mobile device platforms using Mobile Web, the Android operating system (OS) and Apple Iphone, and other available OS. Mobile Web 524—Use these settings to configure images displayed when end users engage a campaign Web site via mobile devices: Campaign Wall Image—this is the campaign wall image for the mobile web platform, size to 640×640 pixels, Mobile Header Image—mobile Web header image, size to 400×70 pixels. iPhone 526—Use these settings to configure images displayed when end users engage with Macintosh iPhone devices: Campaign Icon—110×110 pixels, Performance Image—280×280 pixels, Performance Full View—640×640 pixels, Main Campaign Background Image—320×185 pixels, and Header Image—270×66 pixels. Android 528—Use these settings to configure images displayed when end users engage with Android mobile devices: Campaign Icon—100×100 pixels, Performance Image—280×280 pixels, Performance Full View—640×640 pixels, Main Campaign Background Image—320×185 pixels, and Header Image—270×66 pixels.

Referring to FIGS. 5C-5F, Facebook tab 530 is selected for a Facebook layout. It is noted that Facebook is a non-limiting example, and that other social media platforms can be supported by embodiments of the inventive multi-platform marketing, publishing, and analysis tool described herein. Facebook layouts are different in that there are preconfigured layout options available. To support this, SocialWhirled provides the ability to create multiple layouts for Facebook, though only one layout can be active for your campaign at any one time. To create a new Facebook layout, click on the Create New Layout button 532, and provide a name 534 for the Facebook Layout, select a Layout style 536 (top, center, or left), and click the Save button 538. The Edit button 540 (FIG. 5C) is used to configure a created Facebook layout.

The entry and selection fields of FIG. 5E are used to configure a Facebook layout as follows. A Layout Name 542 is put in the supplied entry area. Active—By clicking the Active checkbox 544, the layout is made into an active layout, though only one layout can be active at one time. Layout Type area 536 displays the type of Facebook Layout. Background Color pull down menu 546 is used to select a background color. Text Color pull down menu 548 is used to select a text color. Leader board header Text field 550 is used to input the text you want displayed over the leaderboard. Leader Board Sort Method is the method used to organize and rank posts by Most Viewed or Most Recent. Number of Posts is used to select the number of posts to display in the leaderboard. Footer Text field 552 is used to input optional text displayed in the Facebook Footer.

FIG. 5F illustrates options for configuring the background for posts on Facebook: Submit Post Background 554 size of this image is dependent upon the selected layout type, e.g.; Fan Gate 556—811×808 pixels; Small Logo 558—76×22 pixels; Wall Header 560—811×206 pixels; Footer Image 562—810×75 pixels; Top—811×237 pixels; Center—811×924 pixels; and Left—395×798 pixels.

FIGS. 6A and 6B combine to form a full composite scrolled screenshot view of the Campaign Manager advanced layout 600 options provided by various coding languages and scripts according to embodiments of the invention. On the Campaign Manager: Advanced Layout screen 600 a user can: write custom hypertext markup language (HTML) for their campaign layout—default HTML code is shown in box 602. Write custom HTML for a performance layout (performance=“posts” to a campaign)—default HTML code is shown in box 604. Write custom JavaScript to be used on campaign and performance layouts in area 606. It is noted that in embodiments any JavaScript will be added to both campaign and post pages, though a user can choose whether to call it or not distinctly from the campaign layout hypertext markup language (HTML) or performance layout HTML. Write custom cascading style sheets (CSS) to be used on campaign and performance layouts in area 608. It is noted that in embodiments any CSS will be added to both campaign and post pages, though you can choose whether to call it or not distinctly from the campaign layout HTML or performance layout HTML. SocialWhirled's Advance Layout section also provides default HTML templates for campaign page and performance page—which provides more or less the same result views as in campaign without advanced layout—allowing a user to start with sample code as they modify their HTML.

FIGS. 7A and 7C are screenshots of the Campaign Manager coupons pages (700A, 700B) for available campaign coupons and coupon layout, respectively according to embodiments of the invention. The coupon section allows a campaign manager (user) to configure a coupon or other deliverable to campaign visitors (end users). Web and Mobile platform coupons are activated and configured in the Coupon tab 702; Facebook coupons are activated in the Coupon tab 702 and layouts are configured in the Coupon Layout tab 704. By default, coupons are inactive unless a user chooses to enable them as a campaign component. If a campaign will be offering coupons, select the Coupon tab 702 and check the box 704 next to Does Your Campaign Offer a Coupon? In section 706 a user may select when to offer the coupon by selecting one of the following radio buttons: “User ‘Likes’ the campaign”—end users must “Like” your campaign in Facebook to gain access to the coupon; “User submits content to campaign”—end users must post content to your campaign to gain access to the coupon; “User provides information”—end users must provide information that has been configured on the Campaign Manager: Information Request feature (see FIG. 12) to gain access to the coupon. A user can optionally type (or cut-and-paste) any terms and conditions in entry area 708 they would like to appear with a coupon. Upload coupon background images 710: For coupons on the Web platform, Upload a background image 600 pixels wide by 396 pixels tall—this image is your end users' coupon. For coupons on the Mobile platform 712, Upload a background 250 pixels wide by 200 pixels tall—this image is the end users' coupon. Click the Save button 714 to enable your coupon settings.

For coupons on Facebook, the Coupon Layout page 700B of FIG. 7B is used to configure additional layout options for different coupon types. A user can create a new Facebook coupon layout or edit/activate an existing Facebook coupon layout they have previously created. At least one Facebook coupon layout must be created before a user can edit (configure) and active a coupon for the Facebook platform. To create a new Facebook coupon layout a user clicks on the Create New Layout . . . button 716, names the coupon layout in entry field 718, and then selects from one of the three preconfigured Facebook page layout designs in layout type 720, and then clicks the Save button 722, taking the user back to the Coupon Layout tab 704.

FIGS. 8A and 8B are screenshots of the interactive user features of the Campaign Manager post page 800 according to embodiments of the invention. In some embodiments there must be at least one initial post before a campaign can be published. To create an initial post: Click on the Post Content by Interest button 802, launching the Create Post Wizard 804. Select the file type for your new post: Video 806, Audio 808, Image 810, and Text 812 from the Create Post Wizard 804 (as determined by your settings on the Campaign Manager: General Information section) and a selected creation page corresponding to the file type is generated as shown in FIGS. 8C-8F. The user is prompted to create, upload content, and publish. It is noted that in embodiments, that SocialWhirled allows a campaign end user to participate in a campaign by contributing content by uploading content including a video, record a video, or link to a YouTube video in H.264 video format for Safari, IE8, or IE7; or Ogg Theora video format for Firefox, Chrome, or Opera. Audio content is accepted in MP3 and WAV format. Image content is accepted in GIF, JPEG, or PNG format. Written content is accepted as either an Adobe PDF file (limited to 1.0 MB) or typed directly in the Text box (limit 2,000 characters).

As shown in FIGS. 8A and 8G current campaign posts will appear in section 814, including view count, how long the posts were made, and any voting/rating. By moving the user's mouse over a current post image (see FIG. 8G, image 816) to optionally: See Post—click on the eye symbol 818 to link to the original post content; Edit Post—click on the pencil symbol 820 to edit or delete post content, including posted video, audio, images, or text, post description, and/or post tags; Publish Settings—click on the globe symbol 822 to modify the post's publish settings (e.g., edit who can view the post, if comments can be viewed, social links to the post from Facebook or Twitter, etc.); Delete Post—click on the X symbol 824 to delete this post from your campaign.

FIGS. 9A and 9B are screenshots of the interactive user features of the Campaign Manager featured post page 900 according to embodiments of the invention. The Campaign Manager featured post page 900 allows a user as campaign manager to add or delete Featured Posts for their campaign. Featured post are selected by the campaign manager and are displayed in order before other posts, regardless of the sort order applied. From this page, Campaign Managers add or remove posts from being “featured” in the campaign. The Add Post button 902 allows a user to search for posts, then select specific posts they would like Featured on their campaign. The Delete All button 906 allows a user to instantly remove all current Featured Posts from their campaign. If a campaign has any Featured Posts 904, they will appear in this list by Post Name. The order of featured posts can be set by dragging and dropping the posts, which will appear in order from top to bottom before any other end-user submitted content. Users have the ability to delete individual posts as Featured Posts using the Delete button 908 next to each current Featured Post. FIG. 9B shows an overlay pop-up 910 for searching for posts.

FIGS. 10A-10E are a series of screenshots for controlling post, comments, flagged posts, and flagged comments on the Campaign Manager moderation page according to embodiments of the invention. The Campaign Manager moderation page 1000 section aggregates the online discussions across all of your campaign platforms, allowing one-step moderation to quickly review, rate, edit, or delete the posts, comments, flagged posts, and flagged comments from your campaign. Additional moderation functionality can be applied by system administrators. System administrators can suspend user accounts or delete content from the platform in addition to the tools provided to campaign managers.

The Post tab 1002 in FIG. 10A lists all existing posts to a campaign, by name, data published, moderator status, and average rating. A Review Status feature (not shown) is also available. All posts are published by default, without needing manual approval, but moderators have the ability to unpublish posts from this screen, using the Decline button 1004 under “Moderator Action” for each individual post. The comments tab 1006 lists all existing comments on posts to a campaign, from newest to oldest, including name of commenter, how long ago comment was made, and options to remove comments with the Remove Comment button next to each comment, or view the original post with the Show Performance button 1008, with an example performance shown in FIG. 10C. The flagged Posts tab 1010 of FIG. 10D lists all flagged posts to a campaign. Moderators have the ability to delete flagged post by selecting the Delete From Campaign button 1012 next to each flagged post. The flagged comments tab 1014 of FIG. 10E lists all flagged comments to posts on a campaign. Moderators have the ability to delete flagged comments by selecting the Delete From Campaign button next to each flagged comment.

FIG. 11 is a screenshot of a contest results page 1100 for informing the Campaign Manager of contest results within a campaign ranked by number of votes or views of posts according to embodiments of the invention. The contest results page 1100 provides a view of top posts by votes or by views with pull down menu 1102. You can also export your campaign participant list to a file with export participant list button 1104 on the contest result screen 1100. The export of campaign participants is done with a comma separated values (.CSV) file format, using the Export Participant List button 1104 and choosing where to save the file. The list file will include thumbnails of each post, post name, posted by, number of votes, and number of views.

FIG. 12A is a screenshot of a page for the Campaign Manager to set parameters for requiring users to provide information prior to posting within a campaign according to embodiments of the invention. The campaign manager user information request page 1200 is used to configure how and what information to request from visitors to a campaign (end users), capturing data from them before allowing them to post content or obtain coupons/deliverables.

If information request is active as checked in box 1202, and the coupon type is “user provides information,” then the information request form data will be presented for end users to complete (along with the coupon Opinion Body question for Facebook coupons). Capturing interest and attribute data gives meaningful information about a target audience, enabling ongoing programs that repurpose content in a way that continually engages an audience specific to their interests. In an embodiment, user information requests are inactive by default unless the user chooses to enable them as a campaign component. The options 1204 for the one or more pieces of data to request include: Phone Number from end users (check the box to enable this request); Address from end users (check the box to enable this request); City from end users (check the box to enable this request); State from end users (check the box to enable this request); and ZIP code from end users (check the box to enable this request). In addition, user defined questions may be included in the information retrieval. For example, User Defined 1 in this case, the “user” is defining their own information request by creating a unique field. The text the user types in this box will be the label that campaign end users see. User Defined 2 again allows the user to define their own information request by creating a unique field. The text the user types in this box will be the label of their campaign that end users see. User Defined 3 also allows the user to define their own information request by creating a unique field. The text the user types in the top box will be the label their campaign end users view, and the text they type in the bottom box will be the choices their end users can select in response to this query. The user may enter as many options as they like in the second box, with a hard return giving each option its own line. User entries are enabled with the checkbox after entering text. By clicking the save button 1206, the information request settings are enabled. A comma-separated values (.CSV) file with the data provided by each end user participating in your campaign may be downloaded by clicking on the Export Campaign Data button 1208. FIG. 12B is a screenshot of an input screen for end users to input requested information in the form of a contest entry.

FIG. 13 is a screenshot of an exemplary campaign page 1300 according to embodiments of the invention. Campaign page 1300 is the result of the previous Campaign Manager screens as described above.

FIG. 14 is a schematic diagram illustrating an overall view of communication devices, computing devices, and mediums for implementing a multi-platform marketing, publishing, and analysis tool according to embodiments of the invention.

The system 1400 includes multimedia devices 1402 and desktop computer devices 1404 configured with display capabilities 1414. The multimedia devices 1402 are optionally mobile communication and entertainment devices, such as cellular phones and mobile computing devices that are wirelessly connected to a network 1408. The multimedia devices 1402 have video displays 1418 and audio outputs 1416. The multimedia devices 1402 and desktop computer devices 1404 are optionally configured with internal storage, computing processors, software, and a graphical user interface (GUI) for carrying out elements of the multi-platform marketing, publishing, and analysis tool according to embodiments of the invention. The network 1408 is optionally any type of known network including a fixed wire line network, cable and fiber optics, over the air broadcasts, satellite 1420, local area network (LAN), wide area network (WAN), global network (e.g., Internet), intranet, etc. with data/Internet capabilities as represented by server 1406. Communication aspects of the network are represented by cellular base station 1410 and antenna 1412. In a preferred embodiment, the network 1408 is a LAN and each remote device 1402 and desktop device 1404 executes a user interface application (e.g., Web browser) to contact the server system 1406 through the network 1408. Alternatively, the remote devices 1402 and 1404 may be implemented using a device programmed primarily for accessing network 1408 such as a remote client.

The software for the multi-platform marketing, publishing, and analysis tool, of embodiments of the invention, may be resident on the individual multimedia devices 1402 and desktop computers 1404, or stored within the server 1406 or cellular base station 1410. Embodiments of the inventive software may be sold or licensed to companies or agencies for running branded campaigns. In embodiments, the server 1406 may implement a cloud-based service for implementing on-demand embodiments of the multi-platform marketing, publishing, and analysis tool with a multi-tenant database for storage of separate client data. In on-demand systems, the inventive software is offered as a service to companies and agencies who conduct their campaigns without owning the software or hardware on which the campaigns are run, but have separate and secure access to their campaigns and their end user data and interactions.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

What is claimed is:

1. A computerized method for providing a multi-platform marketing, publishing, and analysis tool, said method comprising:
providing a campaign management system and graphical user interface (GUI) with real-time analytics for conducting a simultaneous and coordinated publishing and launch of a branded campaign across social media, mobile, and digital targeted Web platforms;
receiving configuration instructions and selected options for the branded campaign from a brand manager using the campaign management system and graphical user interface (GUI);
receiving content, coupons, and contests for the branded campaign from the brand manager to engage a plurality of end users of the social media, mobile, and digital targeted Web platforms;
receiving via a networked connection detailed interest and attribute data about the end users in response to the end user engagement; and
wherein changes to the branded campaign are synchronized so that the changes are reflected across the social media, mobile, and digital targeted Web platforms immediately.

2. The method of claim 1, wherein the GUI is Internet or Web browser based.

3. The method of claim 1, further comprising:
granting access to the campaign management system and GUI to the brand manager, the brand manager having a unique username and password for logging onto the campaign management system and GUI.

4. The method of claim 1, wherein the GUI comprises a series of pages with finable fields, pull down menus, and check boxes.

5. The method of claim 1, wherein the content is at least one of video, audio, image, or text.

6. The method of claim 5, wherein the content is automatically formatted and sized for viewing on each of the end user platforms.

7. The method of claim 1, further comprising:
receiving content from at least one of the plurality of end users; and
wherein the end user contributed content comprises video, audio, images, written information, links to media, and comments and rankings of the end user and brand manager contributed content.

8. The method of claim 7, further comprising:
requiring the end user to register and supply attribute data in order to post content.

9. The method of claim 7, further comprising:
providing a moderator page for the brand manager to monitor and control end user contributed content.

10. The method of claim 1, further comprising:
providing a page and entry fields for the brand manager to enter keywords for interests and metatags to associate with the campaign.

11. The method of claim 1, further comprising:
providing dashboards to gauge the effectiveness of campaigns by performance and event metrics and for capturing the interest and attribute data.

12. The method of claim 11, wherein the dashboards further comprise:
selectable date ranges for displaying the performance and event metrics.

13. The method of claim 11, wherein performance and event metrics comprise:
a sentiment graph displays three bars: Positive, Neutral, and Negative, the size of each bar is determined by the number of posts for each bar with the percentage of the total number of posts being displayed on the far right of the sentiment graph;
a list of keywords/topics that displays the Top 5, Top 10, or Top 20 mentioned keywords, phrases/topics occurring in end user conversations from the social media, mobile, and digital targeted Web platforms, wherein a selection of a specific keyword will open a page displaying end user posts mentioning that keyword;
a conversion rate graph that displays a total conversion rate (total conversations divided by number of posts) for a branded campaign across the social media, mobile, and digital targeted Web platforms; and
a viral impact graph that displays the number of posts per time period across the social media platforms, wherein a selection with a details button shows the time range and total posts count, comments count, and votes count for that range.

14. The method of claim 1, further comprising:
providing a layout page for creating and configuring a consistent layout of the campaign across the social media, mobile, and digital targeted Web platforms.

15. The method of claim 1, further comprising:
providing an advanced layout page for entry of custom hypertext markup language (HTML), JavaScripts, and cascading style sheets (CSS).

16. A system for a multi-platform marketing, publishing, and analysis tool, the system comprising:
a server connected via a network to a brand manager and a plurality of end user devices on social media, mobile, and digital targeted Web platforms;
a memory system in electrical communication with said server containing a machine readable medium having stored thereon one or more sequences of instructions which, when executed, cause a method to be carried out, the method comprising;
providing a campaign management system and graphical user interface (GUI) with real-time analytics for conducting a simultaneous and coordinated publishing and launch of a branded campaign across the social media, mobile, and digital targeted Web platforms;
receiving configuration instructions and selected options for the branded campaign from the brand manager using the campaign management system and graphical user interface (GUI);
receiving content, coupons, and contest for the branded campaign from the brand manager to engage the plurality of end users of the social media, mobile, and digital targeted Web platforms;
receiving via the networked connection detailed interest and attribute data about the end users in response to the end user engagement; and
wherein changes to the branded campaign are synchronized so that the changes are reflected across the social media, mobile, and digital targeted Web platforms immediately.

17. The system of claim 16, wherein the GUI is Internet or Web browser based; and
wherein the GUI comprises a series of pages with finable fields, pull down menus, and check boxes.

18. The system of claim 16, wherein the content is at least one of video, audio, image, or text; and
wherein the content is automatically formatted and sized for viewing on each of the end user devices.

19. The system of claim 16, wherein the end user devices comprise: desktop computers, laptops, mobile computing devices, tablets, smart phones, gaming and entertainment systems, and automotive dashboard displays.

20. A machine-readable medium storing thereon one or more instructions, which when implemented cause a processor to implement a method for providing a multi-platform marketing, publishing, and analysis tool on a computing device, the method comprising:
providing a campaign management system and graphical user interface (GUI) with real-time analytics for conducting a simultaneous and coordinated publishing and launch of a branded campaign across social media, mobile, and digital targeted Web platforms;
receiving configuration instructions and selected options for the branded campaign from a brand manager using the campaign management system and graphical user interface (GUI);
receiving content, coupons, and contests for the branded campaign from the brand manager to engage a plurality of end users of the social media, mobile, and digital targeted Web platforms;
receiving via a networked connection detailed interest and attribute data about the end users in response to the end user engagement; and
wherein changes to the branded campaign are synchronized so that the changes are reflected across the social media, mobile, and digital targeted Web platforms immediately.
